(19) United States
(12) Patent Application Publication
(10) Pub. No.: US 2025/0204642 A1
(43) Pub. Date: Jun. 26, 2025

(54) DUAL CHAMBER FOR ABSORPTION OF A PRESSURE INCREASE

(71) Applicant: BUMPAIR, STRASBOURG (FR)

(72) Inventors: Thomas PANDRAUD, Paris (FR); Timothee BERGERET, Paris (FR); Hugo KAJDAS, Annecy (FR); Alexis PAGNOUX, Le Vesinet (FR); Charles LANGLOIS-MEURINNE, Paris (FR)

(73) Assignee: BUMPAIR, STRASBOURG (FR)

(21) Appl. No.: 18/850,445

(22) PCT Filed: Mar. 29, 2023
(86) PCT No.: PCT/EP2023/058159

§ 371 Date: Sep. 24, 2024

(30) Foreign Application Priority Data
Mar. 29, 2022 (FR) FR2202836
Dec. 20, 2022 (FR) FR2214019

(51) Int. Cl. A43B 13/20; A42B 3/12; A43B 13/18; F16F 9/04

(52) U.S. Cl. CPC A43B 13/20; A42B 3/122; A43B 13/186; F16F 9/049

(57) ABSTRACT

The invention relates to a dual chamber (1) for absorption of a heterogeneous increase in pressure following an impact or a step, comprising a textile outer chamber and an inflatable inner chamber, wherein the textile outer chamber has an upper membrane (2) and a lower membrane (3) which are connected to one another by a lateral membrane (4) and by a plurality of partitions (5), which are preferably sewn together, the partitions (5) being positioned such that the textile outer chamber is forced to assume an angular shape during the inflation of the inner chamber.

### CROSS-REFERENCE TO RELATED PATENT APPLICATIONS

This application is a U.S. National Stage Application under 35 U.S.C. § 371 of International Patent Application No. PCT/EP2023/058159, filed Mar. 29, 2023, which claims the benefit of priority of French Patent Application numbers 2202836 filed Mar. 29, 2022, and 2214019 filed Dec. 20, 2022, all of which are incorporated by reference in their entireties. The International Application was published on Oct. 5, 2023, as International Publication No. WO 2023/186990 A1.

The present invention relates to the field of absorbing an increase in pressure, in particular the field of impact or step damping. The scope of the invention covers problems such as impact absorption, the protection of persons or fragile objects, and the comfort and performance associated with the impact-absorbing properties of the sole of a shoe, particularly a sports shoe.

While it is common to use an air cushion to dampen an impact or absorb an increase in pressure, known technologies have significant drawbacks that limit their use.

Firstly, an inflatable structure tends to take a shape that distributes the internal pressure as evenly as possible, which limits the shapes that known structures can take. Shapes with angles are not permitted. These shapes are not compatible with all applications, and limit the possibility of distributing the absorption of a heterogeneous pressure increase.

In addition, known structures tend to wear out and lose efficiency as the pressure in the air chamber designed to absorb the increase in pressure decreases, which happens naturally over time and with heavy use.

The present invention addresses these shortcomings. By constraining the inflation of a bladder by a second textile envelope that may be semi-rigid or even rigid in places, and comprising a network of internal partitions, a structure capable of taking on irregular shapes and having angles may be obtained. In addition, the asymmetrical arrangement of the partitions provides a variable absorption response to the force applied to the dual chamber, and thus enables a finer heterogeneous response.

Thus, the object of the invention is a dual chamber for the absorption of a heterogeneous pressure increase following an impact or a step, comprising a textile outer chamber and an inflatable inner chamber, wherein the textile outer chamber has an upper membrane and a lower membrane connected to one another by a lateral membrane and by a plurality of partitions, which are preferably sewn together, the partitions being positioned such that the textile outer chamber is forced to assume an angular shape during the inflation of the inner chamber.

The textile outer chamber is not necessarily homogeneous, and may include reinforcements, in particular reinforcements made of rigid or semi-rigid materials, which can help to limit wear of the outer chamber at points that will be subject to high stress. In addition, the presence of rigid or semi-rigid reinforcements can modify the shape of the structure once inflated and fine-tune the response to the pressure increase within the dual chamber. In addition, the use of a composite technical textile for such rigid or semi-rigid reinforcements makes it possible to choose directions of heterogeneous mechanical strengths in order to provide the object with a shape or function when inflated.

The inflatable inner chamber is preferably made of a single deformable material, which may or may not be elastic. Advantageously, the inner chamber is of sufficient thickness to avoid any risk of leakage or puncture, depending on the material used. In addition, the use of an elastic material for the inflatable inner chamber allows it to expand to bridge volume gaps with the outer chamber, thus ensuring a form fit between the inner and outer chambers.

Although this minimum thickness is guaranteed, the inner chamber will nevertheless be as thin as possible, to match the shape of the outer chamber as closely as possible and limit the mass of the dual chamber.

Advantageously, the textile outer chamber furthermore has an intermediate membrane extending substantially parallel to the upper and lower membranes, said intermediate membrane being connected to the upper and lower membranes by the lateral membrane. Such an intermediate membrane makes it possible to locally increase the thickness of the dual chamber, and thus provide a positioning or wedging footprint for it. More precisely, the presence of the intermediate membrane makes it possible to compartmentalize the space available within the textile outer chamber, and to locally generate original shapes of interior space (thanks to the interior volumes created), in particular discontinuous shapes such as, for example, discontinuous “staircase” shapes. The term “discontinuous staircase shape” refers to any shape having a more or less regular sequence of steps (or levels) and risers connecting the steps, the steps being offset from one another in a first direction and extending parallel to one another in a second direction forming an angle with the first direction, the risers extending in the first direction. One possible application is for example when the dual chamber forms part of a protective helmet, with the presence of the intermediate membrane providing a visor or comfort zone for the helmet. Another application is when the dual chamber forms part of a shoe sole, with the presence of the intermediate membrane providing a positioning footprint for the user's foot. Yet another application is when the dual chamber forms part of a protective envelope designed to protect an object or package, the presence of the intermediate membrane then providing a cushioning footprint for the object or package. Optionally, the intermediate membrane can also be connected to the upper and lower membranes by the plurality of partitions.

The dual chamber may comprise a single inner chamber or, alternatively, a plurality of inner chambers. Each chamber can then be inflated independently of the other inner chambers, to a separate pressure level. It is also possible that the dual chamber is designed so that different combinations of inner chambers need to be inflated depending on the intended application. For example, if the dual chamber is used to protect a fragile package, depending on the shape of the package to be protected, which may be tubular, flat or parallelepipedic for example, certain inner chambers may be inflated or deflated. Similarly, if the chamber is used for a shoe sole, depending on whether the shoe is to be used for sports performance or for comfortable walking, different inner envelopes can be inflated. Alternatively, or in combination, the application may depend on the level of inflation of the inflated inner chamber(s).

The dual chamber can include a connection network in the inner chamber enabling the displacement of air and pressure volumes during dynamic movement to be used to improve the comfort or performance of the object. This network may comprise one or more mechanical gas control elements such as check valves, flow regulators, pressure regulators or pressure relief valves. This connection network may also comprise pressure distribution channels. Varying the diameters of the channels can then enable air volumes and pressures to be precisely altered within the dual chamber. The channels can, for example, be made of a plastic material, typically polyurethane, without this being limiting in the context of the present invention.

The inner chambers are preferably straight polyurethane cylinders.

The outer chamber is structured by an upper membrane and a lower membrane, connected to each other by a lateral membrane. Each membrane can be designed independently and attached to the others by any suitable means, in particular by sewing, welding or gluing. In this case, each membrane can be made from a variety of materials, and can be distinguished by its stitching and workmanship.

Alternatively, the assembly can be designed in one piece, for example by weaving, and the distinction between upper membrane, lower membrane, and lateral membrane is then purely topological.

Partitions are positioned between the lower membrane and the upper membrane, and may also have been designed separately and attached, preferably sewn, glued or welded, to the assembly, or alternatively may have been designed in one piece. The partitions can be made of the same material as the lateral membrane, or they can be made of different material(s).

Advantageously, when the dual chamber is a subassembly of a product, the pattern and/or planes of the textile outer chamber allow for a sewing value instead of assembly with another element of the product, thus avoiding the use of other assembly means such as glue. When the dual enclosure is part of a protective helmet, this solution can be used for example to attach a sun protection visor or ear muffs to the helmet. When the dual chamber is part of a shoe sole, it secures the sole to the shoe upper. Such an outer stitching solution can also be used to stitch together elements external to the product.

Not all partitions have the same dimensions or are made from the same materials. Indeed, it may be advantageous to have higher partitions in the center of the dual chamber, for example, to enable the inner chamber to occupy a larger space and be able to absorb greater pressure when a greater impact is anticipated in the center. Similarly, some partitions can be completely rigid so as not to deform under the pressure of the inner chamber and further constrain the shape of the dual chamber. Indeed, if the pressure exerted by the inner chamber on either side of the partition is identical and balanced, the partition will remain flat. However, this balance may be upset, either by the presence of other partitions, or when the dual chamber comprises multiple independent inner chambers that can be inflated to different pressure levels. The rigidity of the partition can then be varied to compensate for this imbalance.

The distribution of partitions is advantageously asymmetrical, with greater partition density resulting in less swelling of the inner chamber and lower pressure absorption. In this way, the distribution of partitions can be used to configure a pressure absorption profile on the dual chamber.

On the outer membranes, the balance between the pressure exerted by the inner chamber and the tension of the outer chamber created by the pressure exerted by the inner chamber on the partitions creates a bulging surface forming an angle at the partitions.

These angles can be used to obtain precise shapes that best suit the geometry of the intended application.

This succession of angles creates a certain undulation that can be controlled by varying the ratio between the spacing of two successive partitions and their height. Providing a sufficiently small spacing between the partitions can limit the bulging of the outer membranes, particularly if they are reinforced with semi-rigid materials, and thus obtain substantially flat or angular surfaces.

An angular shape means a shape that cannot be explained solely by the application of homogeneous pressure to the chamber, and is characterized by changes in the orientation of the surface forming angles, that is to say points or segments of the surface that are not derivable if the thickness of the partitions is considered to be the elementary length of derivation.

Advantageously, the inner chamber has a larger dimension corresponding to the shortest surface of the outer surface of the textile outer envelope with which it is designed to contact when inflated. In particular, this prevents the formation of wrinkles that occur if the inner chamber is too large.

The inner chamber can be attached, preferably sewn, to the outer chamber at multiple points to enable its deployment to be controlled as it inflates, and to ensure good solidarity between the two chambers.

Advantageously, the dual chamber is fitted with a valve, preferably retractable or designed for a needle pump, enabling the inner chamber to be reinflated as required. The dual chamber can also be fitted with one or more pressure indicators.

As such, unlike the air-cushioned shoes of the prior art, for example, it is possible to re-inflate the sole when the pressure decreases under the effect of time and heavy use, or even to adapt the inflation level in the event of a change in use of the shoe.

The invention also relates to a shoe sole comprising a dual chamber according to the invention designed to absorb an increase in pressure caused by a step.

Such a pressure increase is heterogeneous, essentially localized in the heel and forefoot. The distribution of partitions is therefore advantageously organized with less density in these areas. Rigid reinforcements can also be provided at these particularly stressed, wear-sensitive points.

Such a shoe sole according to the invention advantageously stabilizes the runner's foot and recenters it within the shoe.

The dual chamber of the sole according to the invention can advantageously comprise a connection network arranged at the heel of the sole and enabling the weight of the runner to be used to enable the transfer of air and pressure volumes during dynamic motion in order to regulate the pressure of the assembly. In particular, such a connection network distributes the flow of air volumes and pressures between the front and rear of the sole, as the runner's step proceeds (the “heel-to-toe transition”). This eliminates the need for manual re-inflation of the dual chamber. This connection network may comprise mechanical gas control elements such as check valves, flow regulators, pressure regulators or pressure relief valves. This connection network may also comprise pressure distribution channels. Varying the diameters of the channels can then enable air volumes and pressures to be precisely altered within the dual chamber of the sole. The channels can, for example, be made of a plastic material, typically polyurethane, without this being limiting in the context of the present invention.

The invention further relates to a protective helmet comprising a dual chamber according to the invention designed to absorb an impact. This may be a helmet for cyclists, for example.

A helmet can be likened to a half-sphere. The dual chamber then makes it possible to impart a dual curvature to the inner chamber. One of these curvatures, a radial one, is, for example, given by the distribution and orientation of the partitions in relation to each other, while the other curvature, a longitudinal one, can be parallel to the orientation of the inner chambers if they have the shape of cylinders that fill the outer chamber and give it its unfolded shape as they inflate.

The invention also relates to a protective envelope comprising a dual chamber according to the invention designed to protect an object or package from external impact or friction.

These may be packages used to send fragile parcels through the post, or protection systems to prevent damage to parts as they move on conveyors in an industrial structure, for example.

Depending on the application, the reinforced parts and the response profile to increased pressure will be different; in the case of moving on a conveyor belt, the main concern is to protect against friction, and it is possible to anticipate which parts of the protective envelope will be the most stressed, whereas in the case of a postal parcel, it is important to protect against impact, and it is not possible to anticipate which parts of the envelope will be the most stressed.

The ability to deflate the inner chamber(s) advantageously can greatly reduce the volume of the protective envelope, making it easier to reship and reuse.

The present invention will be better understood on reading the following non-limiting example and on examining the appended drawing wherein:

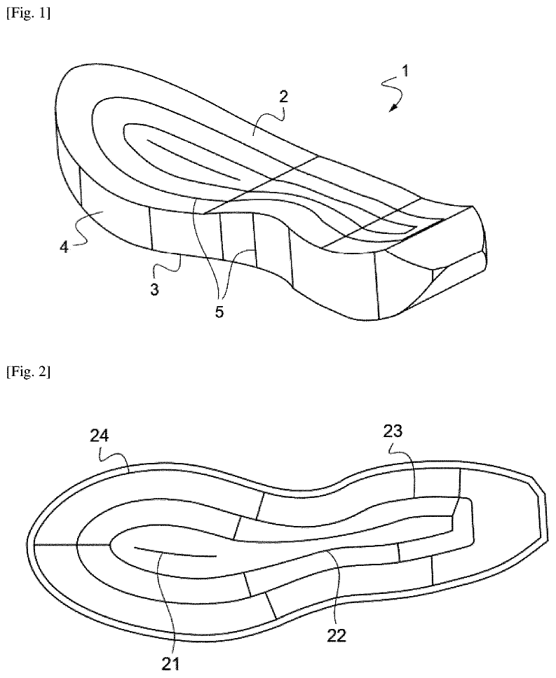

FIG. 1 is a schematic perspective view of a shoe sole according to a first embodiment of the invention,

FIG. 2 is a schematic view of the underside of the sole of FIG. 1,

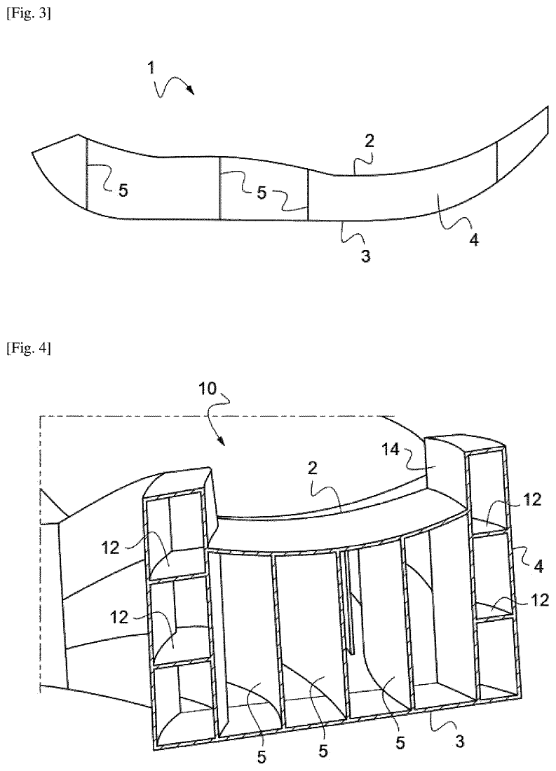

FIG. 3 is a schematic sectional view of the sole of FIG. 1 in an anteroposterior vertical plane, and

FIG. 4 is a schematic perspective and cross-sectional view (along a vertical plane) of a shoe sole according to a second embodiment of the invention.

In the figures, the relative proportions of the various components have not been drawn to scale and do not match reality, for the sake of greater clarity.

In a first embodiment shown in FIGS. 1 to 3, the invention relates to a shoe sole comprising a dual chamber.

The dual chamber 1 consists of a textile envelope and an inflatable bladder.

The textile envelope is made of reinforced polyamide and comprises an upper membrane 2 and a lower membrane 3, connected by a lateral membrane 4 and partitions 5. The textile envelope may further comprise reinforcements (not shown) judiciously placed at certain points of the sole to reinforce it locally, in particular reinforcements made of rigid or semi-rigid materials.

The shapes of the various parts making up the textile envelope are created by laser cutting. Areas with sharp curves are notched.

The individual membranes 2, 3 and 4 are joined together by means of sewing, welding or gluing. If the individual membranes 2, 3, 4 are sewn together, the stitching is such that the underside has no visible seams. In fact, apart from their unsightly appearance, seams also constitute a weak point that should not be placed in an area likely to be subjected to significant stress, in order to increase the sole's durability.

The bladder is made of polyurethane cylinders. To form these cylinders, a polyurethane film is cut into boards with shapes corresponding to a lower and upper part of the cylinder. One of the boards has an opening for inserting a valve. The two boards are then welded together to form the cylinder. A valve is then welded to the opening provided for this purpose.

Complementary elements can then be inserted into the valve, such as a bullet shape or fins.

When assembling the dual chamber, some cylinders are advantageously inserted into the textile envelope before all the assembly seams have been sewn. Other cylinders can be inserted at a later date.

Thus, the seam 21 is first sewn to the upper membrane 2, then a first cylinder is inserted before the seam 22 is in turn sewn to the upper membrane 2, trapping the first cylinder. A second cylinder is then positioned before the seam 23 in turn locks it in place. Finally, a third cylinder is positioned between seam 23 and the outer seam 24, which encloses the third cylinder.

The partitions 5 are not all of the same height, giving the dual chamber an undulating shape that best matches the arch of the foot.

In the center of the sole, the partitions 5 are closer together, as this part of the sole will not be subject to much stress. Conversely, in the heel and forefoot areas, the partitions 5 are spaced further apart to provide larger chambers, suitable for larger and more frequent impacts.

Some partitions 5 are not the full height of the dual chamber, which may allow bladder cylinders to be forced through.

The bladder features a retractable valve and a pressure indicator, not shown, enabling one of the three cylinders to be re-inflated if the inflation level of one of them is no longer adequate for the intended use of the sole.

Another shoe sole comprising a dual chamber 10 is shown in FIG. 4, according to a second embodiment of the invention. In addition to the upper membrane 2, lower membrane 3, lateral membrane 4 and partitions 5, the textile outer chamber of the dual chamber 10 also comprises a plurality of intermediate membranes 12. Each intermediate membrane 12 extends substantially parallel to the upper membrane 2 and the lower membrane 3, and is connected to the upper membrane 2 and the lower membrane 3 by the lateral membrane 4. The intermediate membranes 12 define compartmentalized interior spaces which can be inflated independently of each other and independently of the spaces delimited by the partitions 5, thereby locally increasing the thickness of the dual chamber 10, and thus providing a positioning or wedging footprint for it. In the example shown, the presence of intermediate membranes 12 makes it possible to locally generate discontinuous “staircase” shapes 14.

The expression “comprising one” is to be understood as “comprising at least one” unless otherwise specified.

1. A dual chamber (1; 10) for the absorption of a heterogeneous pressure increase following an impact or a step, comprising a textile outer chamber and an inflatable inner chamber, wherein the textile outer chamber has an upper membrane (2) and a lower membrane (3) which are connected to one another by a lateral membrane (4) and by a plurality of partitions (5), which are preferably sewn together, the partitions (5) being positioned such that the textile outer chamber is forced to assume an angular shape during the inflation of the inner chamber.

2. The dual chamber (10) according to claim 1, characterized in that the textile outer chamber furthermore has an intermediate membrane (12) extending substantially parallel to the upper membrane (2) and lower membrane (3), said intermediate membrane being connected to the upper membrane (2) and lower membrane (3) by the lateral membrane (4).

3. The dual chamber (1; 10) according to claim 1, characterized in that the textile outer chamber comprises reinforcements, in particular reinforcements made of rigid or semi-rigid materials.

4. The dual chamber (1; 10) according to claim 1, characterized in that the inflatable inner chamber is made of a single deformable material.

5. The dual chamber (1; 10) according to claim 1, characterized in that the dual chamber (1; 10) comprises a plurality of inflatable inner chambers, each inner chamber being capable of being inflated independently of the other inner chambers, to a distinct pressure level.

6. The dual chamber (1; 10) according to claim 1, characterized in that the dual chamber (1; 10) comprises a connection network arranged in the inflatable inner chamber and designed to displace air and pressure volumes in the inner chamber when the dual chamber (1; 10) experiences dynamic motion.

7. The dual chamber (1; 10) according to claim 6, characterized in that the connection network comprises one or more mechanical gas control elements such as check valves, flow regulators, pressure regulators or pressure relief valves.

8. The dual chamber (1; 10) according to claim 1, claims, characterized in that the distribution of the plurality of partitions (5) is asymmetrical.

9. The dual chamber (1; 10) according to claim 1, characterized in that the inflatable inner chamber is attached to the textile outer chamber at a plurality of points.

10. A shoe sole comprising a dual chamber (1; 10) according to claim 1, designed to absorb an increase in pressure caused by a step.

11. A protective helmet comprising a dual chamber (1; 10) according to claim 1, designed to absorb an impact.

12. A protective chamber envelope comprising a dual chamber (1; 10) according to claim 1, designed to protect an object or package from external impact or friction.
